(19) United States
(12) Patent Application Publication
(10) Pub. No.: US 2019/0317986 A1
(43) Pub. Date: Oct. 17, 2019

(54) ANNOTATED TEXT DATA EXPANDING METHOD, ANNOTATED TEXT DATA EXPANDING COMPUTER-READABLE STORAGE MEDIUM, ANNOTATED TEXT DATA EXPANDING DEVICE, AND TEXT CLASSIFICATION MODEL TRAINING METHOD

(71) Applicant: PREFERRED NETWORKS, INC., Tokyo (JP)

(72) Inventor: Sosuke KOBAYASHI, Tokyo (JP)

(73) Assignee: PREFERRED NETWORKS, INC., Tokyo (JP)

(21) Appl. No.: 16/383,065

(22) Filed: Apr. 12, 2019

(30) Foreign Application Priority Data
Apr. 13, 2018 (JP) 2018-077810

(51) Int. Cl. G06F 17/24; G06N 3/08; G06F 17/18; G06F 17/27

(52) U.S. Cl. CPC G06F 17/241; G06F 17/273; G06F 17/18; G06N 3/08

(57) ABSTRACT

The present disclosure provides an annotated text data expanding method capable of obtaining a large amount of annotated text data, which is not inconsistent with an annotation label and is not unnatural as a text, by mechanically expanding a small amount of annotated text data through a natural language processing. The annotated text data expanding method includes inputting, by an input device, the annotated text data including a first text appended with a first annotation label to a prediction complementary model. New annotated text data is created by one or more processors by the prediction complementary model, with reference to the first annotation label and context of the first text.

### CROSS-REFERENCE OF RELATED APPLICATION

This application claims the benefit of and priority to Japanese Patent Application No. 2018-77810, filed Apr. 13, 2018, the entire contents of which are incorporated herein by reference.

### FIELD

The present disclosure relates to an annotated text data expanding method, an annotated text data expanding computer-readable storage medium, an annotated text data expanding device, and a text classification model training method.

### BACKGROUND

Among applications using a natural language processing, one dealing with a text classification problem (also called an identification problem) is applicable to the use for automatically classifying a large amount of text data. Then, various technologies have recently been developed, for example, a technology for improving a classification accuracy when categories of newspaper articles are automatically estimated.

In an application dealing with a text classification problem, generally, “supervised learning” is performed in which annotated text data appended with annotation (related annotation information) as a label (hereinafter, an annotation label) is given as training data, and learning is performed. Then, classification of unknown data (classification by giving any of labels) is performed by using a model parameter obtained as a result of the learning (hereinafter, referred to as a model). In order to achieve a high classification accuracy (hereinafter, also simply referred to as a “high accuracy”) through such a machine learning method, in general, a large amount of annotated text data is required as training data.

A task of appending an annotation label to a text is usually manually performed, and thus requires labor and costs. In particular, when a text relates to a field whose contents cannot be understood without premises on original knowledge or rules, the task of giving the annotation label requires a huge amount of labor and costs. Thus, it is not realistically possible to manually prepare a large amount of annotated text data sufficient to achieve a high accuracy.

Meanwhile, as a data expanding method in a natural language processing, developed is a method of replacing a word in annotated text data with a synonym by using a previously prepared synonym dictionary.

However, in the method of replacing with a synonym, the creation of the synonym dictionary requires labor. Moreover, a data expansion range stays within a range of synonyms of words. Thus, it is difficult to prepare a large amount of annotated text data sufficient to achieve a high accuracy.

The above data expanding method is based on the premise that there is a certain amount of existing annotated text data, and creation of such prerequisite amount of annotated text data requires labor.

### SUMMARY

Embodiments of the present disclosure relates to an annotated text data expanding method, an annotated text data expanding computer-readable storage medium, an annotated text data expanding device, and a text classification model training method.

According to certain aspects, embodiments provide a method for expanding annotated text data. According to the method, annotated text data may be input including a first text appended with a first annotation label to a prediction complementary model. New annotated text data may be created by the prediction complementary model, with reference to the first annotation label and context of the first text.

According to certain aspects, embodiments provide a non-transitory computer readable storage medium storing a program for expanding annotated text data, the program, when executed by one or more processors, causing the one or more processors to perform an expansion of the annotated text data. The program may cause the one or more processors to execute input annotated text data including a first text appended with a first annotation label to a prediction complementary model, and create new annotated text data by the prediction complementary model, with reference to the first annotation label and context of the first text.

According to certain aspects, embodiments provide a device for expanding annotated text data. The device may include a processor, an input device, and a storage. The input device may be configured to input annotated text data including a first text appended with a first annotation label. The storage may store a prediction complementary model. The processor may be configured to perform arithmetic processings of creating new annotated text data by the prediction complementary model, with reference to the first annotation label and context of the first text.

### Effects

According to embodiments of the present disclosure, it is possible to provide an annotated text data expanding method, an annotated text data expanding computer-readable storage medium, an annotated text data expanding device, and a text classification model training method, in which a small amount of annotated text data is mechanically expanded by a natural language processing so as to obtain a large amount of annotated text data that is not inconsistent with an annotation label and is not unnatural as a text.

### BRIEF DESCRIPTION OF DRAWINGS

FIG. 1 is a block diagram illustrating a functional configuration of an annotated text data expanding device according to an embodiment;

FIG. 2 is a view illustrating the flow of arithmetic processings (b-1) to (b-3) according to an embodiment;

FIG. 3 is a block diagram illustrating a hardware configuration of the annotated text data expanding device according to an embodiment; and

FIG. 4 is a view illustrating the results of [Arithmetic Example B].

### DETAILED DESCRIPTION

The present disclosure has been made in view of such circumstances, and an object of the present disclosure may be to provide an annotated text data expanding method, an annotated text data expanding computer-readable storage medium, an annotated text data expanding device, and a text classification model training method, in which a small amount of annotated text data is mechanically expanded by a natural language processing so as to obtain a large amount of annotated text data that is not inconsistent with an annotation label and is not unnatural as a text.

The present inventors performed intensive studies in order to solve the above described problems, and as a result, they found that it is possible to solve the problems by performing an arithmetic processing by using a specific prediction complementary model. The present disclosure provides solutions based on this finding.

In some embodiments, a method for expanding annotated text data may include (a) an input step of inputting annotated text data including a text S appended with an annotation label y to a prediction complementary model, and (b) a step of creating new annotated text data by the prediction complementary model, with reference to the annotation label y and context of the text S. In some embodiments, the step (b) may include performing arithmetic processings (b-1) to (b-3) as indicated below:

(b-1) extracting an element wᵢ′ replaceable with an element wᵢ within the text S, by an extraction method provided in the prediction complementary model;

(b-2) creating a text S′ by replacing the element wᵢ within the text S with the element wᵢ′; and

(b-3) appending the annotation label y to the text S′.

In some embodiments, in the method for expanding annotated text data, the prediction complementary model may be a label-conditioned bidirectional language model. In some embodiments, wherein the extraction method may include calculating a probability distribution by a following equation (1):

p_{τ}(·|y,S\{wᵢ}) (1)

wherein τ represents a temperature parameter, y represents an annotation label, S represents a text, and wᵢ represents an element in a text.

In some embodiments, in the method for expanding annotated text data, the element is a word. In some embodiments, the method for expanding annotated text data may include a pre-step of training the prediction complementary model by using a text data set having no label as training data, prior to the input step.

In some embodiments, a program for expanding annotated text data may cause a computer or one or more processors (e.g., CPU, GPO to perform an expansion of annotated text data. In some embodiments, the program may cause the computer to execute (a) an input step of inputting annotated text data including a text S appended with an annotation label y to a prediction complementary model, and (b) a step of creating new annotated text data by the prediction complementary model, with reference to the annotation label y and context of the text S.

In some embodiments, in the program for expanding annotated text data, the step (b) may include performing arithmetic processings (b-1) to (b-3) as indicated below:

(b-1) extracting an element wᵢ′ replaceable with an element wᵢ within the text S, by an extraction method provided in the prediction complementary model;

(b-2) creating a text S′ by replacing the element wᵢ within the text S with the element wᵢ′; and

(b-3) appending an annotation label y identical to the text data, to the text S′.

In some embodiments, a device for expanding annotated text data may include an annotated text data input unit that inputs annotated text data including a text S appended with an annotation label y, a prediction complementary model storage that stores a prediction complementary model, and an arithmetic unit that performs arithmetic processings of creating new annotated text data by the prediction complementary model, with reference to the annotation label y and context of the text S.

In some embodiments, in the device for expanding annotated text data, the arithmetic processings may include (b-1) to (b-3) as indicated below:

(b-1) extracting an element wᵢ′ replaceable with an element wᵢ within the text S, by an extraction method provided in the prediction complementary model;

(b-2) creating a text S′ by replacing the element wᵢ within the text S with the element wᵢ′; and

(b-3) appending an annotation label y identical to the text data, to the text S′.

In some embodiments, in the device for expanding annotated text data, the arithmetic unit may include a replacement element extractor that performs the arithmetic processing (b-1), a text creating unit that performs the arithmetic processing (b-2), and a label assigning unit that performs the arithmetic processing (b-3).

In some embodiments, a method of training a text classification model may include an expanded data set obtained by the annotated text data expanding method described above as training data for a text classification model.

Hereinafter, embodiments of the present disclosure will be described. Meanwhile, the present disclosure is not limited to the described embodiments.

<Annotated Text Data Expanding Device and Annotated Text Data Expanding Method>

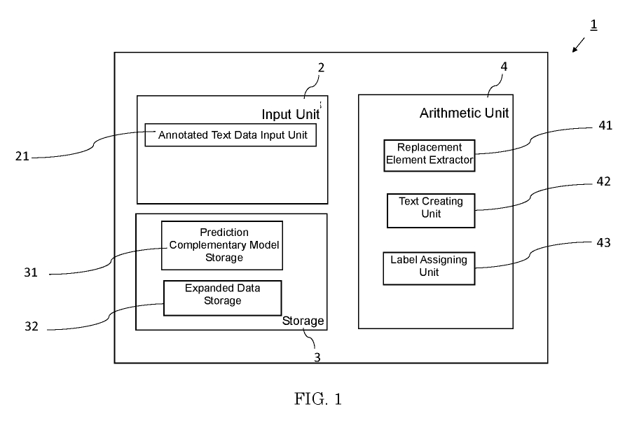

FIG. 1 is a block diagram illustrating a functional configuration of an annotated text data expanding device 1 used for an annotated text data expanding method according to an embodiment.

The annotated text data expanding device 1 according to an embodiment includes an input unit 2, a storage 3, and an arithmetic unit 4.

The input unit 2 includes an annotated text data input unit 21, the storage 3 includes a prediction complementary model storage 31, and the arithmetic unit 4 includes a replacement element extractor 41, a text creating unit 42, and a label assigning unit 43. The storage 3 may also include an expanded data storage 32.

In the arithmetic unit 4 of the annotated text data expanding device 1 according to an embodiment, an arithmetic processing may be performed on annotated text data input from the annotated text data input unit 21 by using a prediction complementary model stored in the prediction complementary model storage 31.

Through this arithmetic processing, a small amount of annotated text data (the input annotated text data) may be expanded to a large amount of annotated text data. At least one or more of the replacement element extractor 41, text creating unit 42, and label assigning unit 43 (of the arithmetic unit 4) may be implemented with processing circuitry, for example, a special circuit (e.g., circuitry of a FPGA or the like), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like. Here, the term “processing circuitry” refers to “FPGA, CPU, GPU or other processing devices implemented on electronic circuits. At least one or more of the prediction complementary model storage 31 and expanded data storage 32 of the storage 3 may be implemented with EPROM, EEPROM, SDRAM, and flash memory devices, CD ROM, DVD-ROM, or Blu-Ray® discs and the like) and executable by a processor (e.g., CPU, GPU and the like. In some embodiments, the input unit 2 may be implemented with various input devices such as a keyboard or a touch panel.

The type of the annotated text data input from the annotated text data input unit 21 is not particularly limited as long as the data is text data having an annotation label attached thereto. Here, a text means a character string, and includes sequence data or sensor data as well as a sentence.

The prediction complementary model may be a model used for obtaining annotated text data expanded from the input annotated text data, and may be desirably based on a language model based on bidirectional long-short term memory (LSTM)-recurrent neural networks (RNN).

Before the annotated text data is input to the prediction complementary model, it is desirable to perform training of the prediction complementary model using a text data set (a text data set having no label) to which no annotation label y is appended, as training data.

For example, an annotated text data set to be used as training data for a classification model for performing evaluation classification on a movie review site may be created by an expansion method of the present disclosure. In some embodiments, before annotated training data (e.g., text data “the actors are fantastic.” and an annotation label “positive”) is input to the prediction complementary model, in a pre-step, the prediction complementary model may be trained by using a text data set (such as WikiText-103 corpus) having no label. In this manner, it is possible to improve the performance of the prediction complementary model by increasing choices of words exchangeable without contradiction in context. Here, a “positive” annotation label indicates that text data has a positive meaning, and a negative annotation label indicates that text data has a negative meaning.

Here, the context refers to (1) a connection state of semantic contents between words, (2) a syntactic relationship before or after a specific word, or (3) words or sentences themselves in dependency relationships or (4) a logical relationship with such words or sentences, in text data. In the case of a continuously input text (e.g., sequence data or sensor data), a connection state or a logical relationship between a specific target portion data and its surrounding data, and data itself in the vicinity thereof are also called the context.

The prediction complementary model may include methods for performing arithmetic processings (b-1) to (b-3) below.

(b-1): extracting an element wᵢ′ replaceable with an element wᵢ within the text S by an extraction method;

(b-2): creating a text S′ by replacing the element wᵢ within the text S with the element wᵢ′;

(b-3): creating new annotated text data including an annotation label y identical to the text data, to the text S′.

The arithmetic processing (b-1) may be performed by the replacement element extractor 41 of the arithmetic unit 4, the arithmetic processing (b-2) may be performed by the text creating unit 42, and the arithmetic processing (b-3) may be performed by the label assigning unit 43.

The replacement element extractor 41 may extract the element replaceable with the element wᵢ within the text S by the extraction method provided in the prediction complementary model.

For example, when a text constituting the text data is a sentence S as a closed sentence constituted by arranging a plurality of words as elements, the probability that the word wᵢ′ as a replacement candidate of wᵢ may be present at a position i of the sentence S may be calculated according to the following equation (2) in accordance with the context of the sentence S. Then, a probability distribution of the replacement candidate of wᵢ may be obtained.

As the probability increases, the exchangeability of a word increases. In some embodiments, it is possible to extract a word with a probability equal to or higher than a predetermined probability, as the replaceable element wᵢ′.

In this manner, by using a probability distribution, it is possible to extract a plurality of exchangeable words at once.

p(·|S\{wᵢ}) (2)

When the prediction complementary model is based on the language model based on the bidirectional LSTM-RNN, it is possible to obtain a probability distribution with a higher accuracy by combining results of forward estimation and backward estimation.

By using a quantum annealing method, it is possible to obtain a probability distribution with a higher accuracy. In some embodiments, it is possible to obtain a probability distribution with a higher accuracy by introducing a temperature parameter τ into the above equation (2), and using an annealing distribution obtained in the following equation (3).

p_{τ}(·|S\{wᵢ})∝p(·|S\{wᵢ})^{1/τ} (3)

Since the equation (2) or the equation (3) focuses on only the text data in the input annotated text data, in a case where annotated text data constituted by, for example, a combination of text data “the actors are fantastic.” and an annotation label “positive” is input, and a word exchangeable with “fantastic” in the text data is extracted by the above described method, “good,” “entertaining,” “bad,” and “terrible” may be extracted as words exchangeable without contradiction in context. Among these, “bad” and “terrible” are inconsistent with the annotation label “positive.” Thus, when expanded annotated text data including these is included in training data, and used as training data of a text classification model, there is a possibility that a classification accuracy is lowered.

The present inventors found that it is possible to prevent this problem by introducing a conditional constraint that word replacement is performed in a range where there is no inconsistency with the annotation label y. For example, a probability distribution may be calculated by the following equation (4) in which the embedded label y is connected to a hidden layer of a feed forward network of bidirectional LSTM-RNN so that it is possible to extract a word that is exchangeable without contradiction in context and constitutes a text having no inconsistency with annotation information of the annotation label y.

p_{τ}(·|y,S\{wᵢ}) (4)

(In the above equation (4), τ represents a temperature parameter, y represents an annotation label, S represents a text, and wᵢ represents an element within a text.)

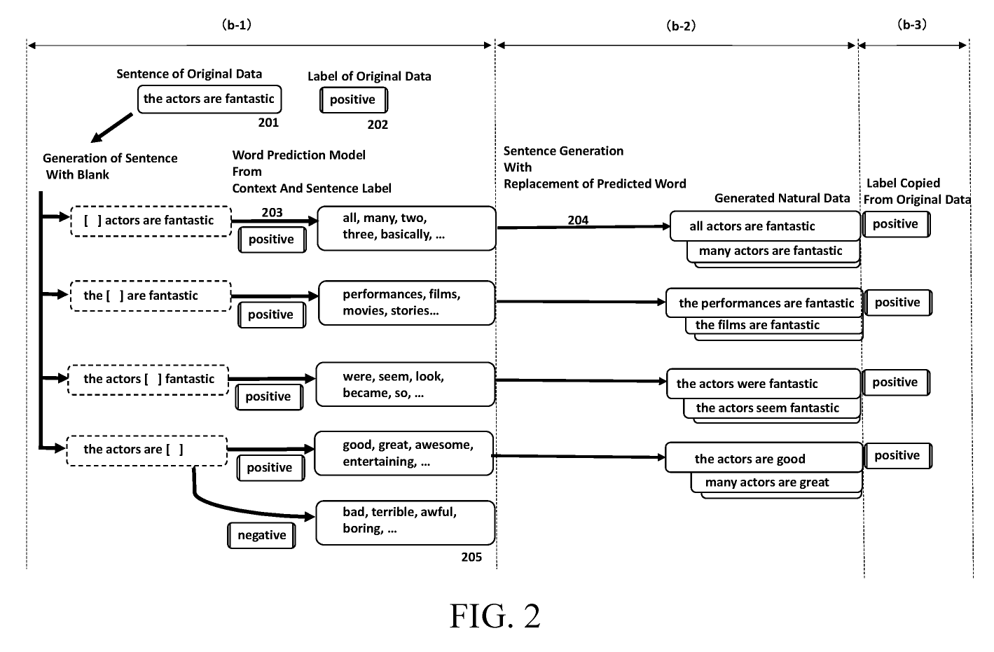

FIG. 2 is a view illustrating the flow of the arithmetic processings (b-1) to (b-3). For example, the combination of text data 201 “the actors are fantastic” and a label 202 “positive” may be input.

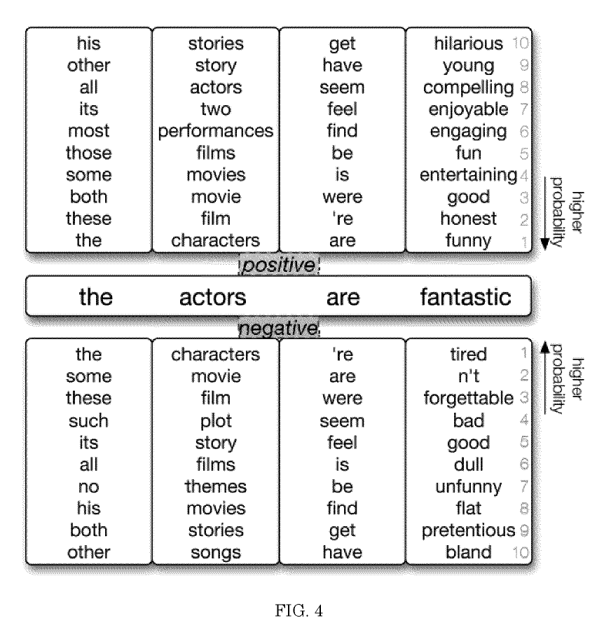

In (b-1), the element is extracted from a text S (e.g., “the actors are fantastic” in FIG. 2). In some embodiments, a sentence with blank may be generated from the text S, for example, “the actors are [ ]”. A model (e.g., a word prediction model 203 in FIG. 2) is expected to generate elements (e.g., “good”, “great”, “awesome”, “entertaining”) consistent with annotation information y (e.g., the “positive” label 202). This process may be a one-stage process and may not be a process of “generating elements both consistent or inconsistent with y, and subsequently filtering out inconsistent ones.” That is, the model may generate elements consistent with y at once according to the equation (4) (while models according to the equation (3) can generate both consistent and inconsistent elements, because they do not have y as an input variable). For example, if y is a “negative” label, the model generates elements 205 consistent with “negative”, e.g., “bad”, “terrible”, “awful”, “boring”, as shown in FIG. 2, which is a different set of data from those consistent with the “positive” label. This usage of generating elements according to a “positive” label or a “negative” label was used in the experiment illustrated in FIG. 4 and to be described in paragraph [0071].

In (b-2), sentence generation with replacement of predicted word may be performed (204 in FIG. 2). For example, the text S′ (e.g., “the actors are good”) may be created by replacing the element wᵢ (e.g., “fantastic”) within the text S with the element wᵢ′ (e.g., “good”). In (b-3), a label for the generated (created) text S′ may be created by copying the original label (e.g., “positive” 202 in FIG. 2). In other words, new annotated text data may be created including the text S′ and an annotation label y identical to that of the original text data.

The new annotated text data created in (b-3) may be stored in the expanded data storage 32 of the storage 3, and then may be used as training data for further training of the prediction complementary model or may be collectively taken out as an enhanced expanded data set.

<Hardware Configuration>

In a general-purpose computer device used as basic hardware, it is possible to realize a processing of the above embodiment by causing a processor (or a processing circuit) such as a central processing unit (CPU) mounted in the computer device to execute a program. That is, a configuration is made such that the processor (or processing circuit) may execute each of the arithmetic processings (b-1) to (b-3) through execution of the corresponding program.

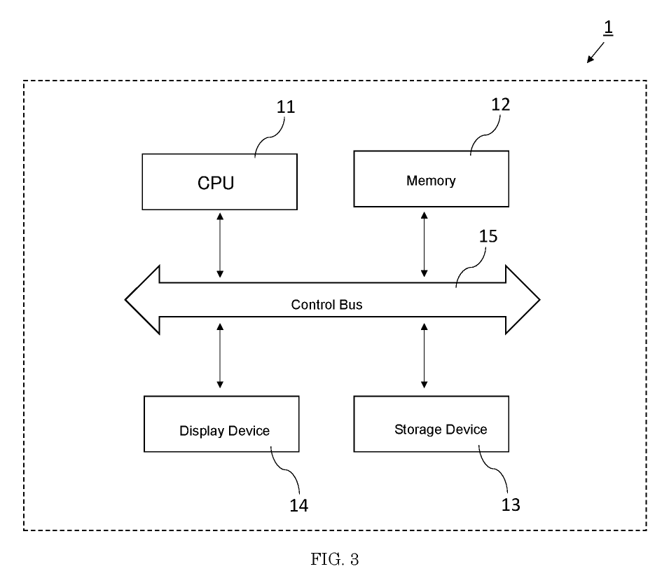

FIG. 3 is a view illustrating an embodiment of a hardware configuration of the annotated text data expanding device 1. In the embodiment in FIG. 3, the annotated text data expanding device 1 includes a CPU 11, a memory 12, a storage device 13 such as a hard disk drive (HDD), and a display device 14, and these constituent elements are connected to each other via a control bus 15.

The CPU 11 executes a predetermined processing on the basis of a control program stored in the memory 12 or the storage device 13 (or provided from a computer-readable storage medium such as a CD-ROM (not illustrated)) so as to control an operation of the annotated text data expanding device 1.

In the embodiment of the present disclosure, the annotated text data expanding device 1 may further include various input interface devices such as a keyboard or a touch panel.

<Annotated Text Data Expanding Program>

A series of procedures in each annotated text data expanding method described in the above described embodiment may be embedded in a program and then may be executed through reading by a computer. Accordingly, each series of procedures in the annotated text data expanding method according to the present disclosure may be realized by using a general-purpose computer. Further, a program may be stored in a recording medium such as a flexible disk or a CD-ROM, as a program for causing a computer to execute each series of procedures in the annotated text data expanding method as described above, and then may be executed through reading by the computer. The recording medium is not limited to a portable one such as a magnetic disk or an optical disk, but may be a fixed-type recording medium such as a hard disk device or a memory. The program in which each series of procedures in the annotated text data expanding method as described above are embedded may be distributed through a communication line (including a wireless communication) such as the Internet. The program in which each series of procedures in the annotated text data expanding method as described above are embedded may be distributed in an encrypted, modulated, or compressed state, via a wired line or a wireless line, such as the Internet, or may be distributed while stored in the recording medium.

When dedicated software stored in a computer readable storage medium is read by a computer, the computer may become the device of the above embodiment (e.g., the annotated text data expanding device 1). The type of the storage medium is not particularly limited. When dedicated software downloaded via a communication network is installed by a computer, the computer may become the device of the above embodiment (e.g., the annotated text data expanding device 1). In this manner, an information processing by software is specifically implemented by using hardware resources.

At least a part of the above embodiment may be realized by a dedicated electronic circuit (that is, hardware) that implements a processor and a memory, such as an integrated circuit (IC).

<Text Classification Model Training Method>

By using the expanded data set obtained by the annotated text data expanding method described in the above described embodiment, as training data of a text classification model, it is possible to improve a classification accuracy in all the text classification models.

Use examples of the text classification model include a classification model that automatically classifies reviews posted on a review site of movies into positive evaluation and negative evaluation according to the contents, a classification model that automatically classifies categories of newspaper articles into “economy” “politics” “sports,” and “culture”, a classification model that automatically classifies sequence data by systems, a classification model that automatically classifies sensor data by evaluation levels, a classification model that automatically classifies questions to customer support by inquiry categories, a classification model that automatically classifies articles in a web site by categories, and a classification model that automatically classifies human speech contents directed to a robot through text conversion.

Also, in the field of a chemical technology, for example, in the Act on the Evaluation of Chemical Substances and Regulation of Their Manufacture, etc. (Chemical substance control law), when new chemical substances are reported, it is possible to perform an application of a classification model that automatically classifies harmfulness information according to the type or structure of an element with respect to a database of existing substances.

### EXAMPLES

Hereinafter, Examples will be described, and the present disclosure will be described in more detail.

### Arithmetic Example A

Table 1 (see below) illustrates results when verification is performed, by six types of classification models (STT5, STT2, Subj, MPQA, RT, and TREC), on an expanded data set obtained by using eight methods as prediction complementary models—(1) Convolutional neural network (CNN) (Comparative Example 1), (2) “w/synonym” (Comparative Example 2), (3) “w/context (Comparative Example 3), (4) “+label” (Example 1), (5) “LSTM-RNN (Comparative Example 4), (6) “w/synonym” (Comparative Example 5), (7) “w/context” (Comparative Example 6), and (8) “+label (Example 2)” in Table 1. Numerical values in Table 1 indicate the accuracy of classification.

Comparative Example 1 illustrates the results of verification on an expanded data set obtained from a prediction complementary model using only a method of a neural network (CNN). Comparative Example 4 illustrates the results of verification on an expanded data set obtained from a prediction complementary model using only a method of a neural network (LSTM-RNN).

Comparative Example 2 illustrates the results of verification on an expanded data set obtained from a combination of a prediction complementary model using a method of a neural network (CNN) and data expansion using a manually created synonym database (for example, manually creating, from word a, set B of synonyms of the word a, such as, set of {b1, b2, . . . }). In the data expansion using a synonym database, a word a in a sentence may be chosen by a probability p. In some embodiments, the probability p may be a parameter set by a user, taking a value between [0, 1]. Then, the word a may be replaced with a word sampled with a uniform distribution from a set including synonyms and a, that is, {a, b1, b2, . . . }.

Comparative Example 5 illustrates the results of verification on an expanded data set obtained from a combination of a prediction complementary model using a method of a neural network (LSTM-RNN) and data expansion using the above synonym database.

Each of Comparative Example 3 and Comparative Example 6 illustrates the results of verification on an expanded data set that includes data expanded through replacing with a word obtained from a probability distribution calculated in the following equation (5) when a prediction complementary model in which a method used in each of Comparative Example 1 and Comparative Example 4 is added to a method that extracts a word exchangeable without contradiction in context is used.

p_{τ}(·|S\{wᵢ}) (5)

Each of Example 1 and Example 2 illustrates the results of verification on an expanded data set that includes data expanded through replacing with a word obtained from a probability distribution calculated in the following equation (6) when a prediction complementary model in which a method used in each of Comparative Example 1 and Comparative Example 4 is added to a method that replaces with a word that is exchangeable without contradiction in context and constitutes a text having no inconsistency with annotation information is used.

p_{τ}(·|y,S\{wᵢ}) (6)

In the above equation (6), τ represents a temperature parameter, y represents an annotation label, S represents a text, and wᵢ represents an element in a text.

STT5, STT2, and RT are classification models that classify movie reviews.

Subj is a classification model that classifies sentences into “subjective” and “objective.”

MPQA is a classification model that detects polarity (positive, negative) in short phrases.

TREC is a classification model that performs classification into six question types such as “person” and “thing.”

TABLE 1

| | Models | STT5 | STT2 | Subj | MPQA | RT | TREC | Avg. |
|---|---|---|---|---|---|---|---|---|
| Comparative | CNN | 41.3 | 79.5 | 92.4 | 86.1 | 75.9 | 90.0 | 77.53 |
| Example 1 | | | | | | | | |
| Comparative | w/synonym | 40.7 | 80.0 | 92.4 | 86.3 | 76.0 | 89.6 | 77.50 |
| Example 2 | | | | | | | | |
| Comparative | w/context | 41.9 | 80.9 | 92.7 | 86.7 | 75.9 | 90.0 | 78.02 |
| Example 3 | | | | | | | | |
| Example 1 | +label | 42.1 | 80.8 | 93.0 | 86.7 | 76.1 | 90.5 | 78.20 |
| Comparative | RNN | 40.2 | 80.3 | 92.4 | 86.0 | 76.7 | 89.0 | 77.43 |
| Example 4 | | | | | | | | |
| Comparative | w/synonym | 40.5 | 80.2 | 92.8 | 86.4 | 76.6 | 87.9 | 77.40 |
| Example 5 | | | | | | | | |
| Comparative | w/context | 40.9 | 79.3 | 92.8 | 86.4 | 77.0 | 89.3 | 77.62 |
| Example 6 | | | | | | | | |
| Example 2 | +label | 41.1 | 80.1 | 92.8 | 86.4 | 77.4 | 89.2 | 77.83 |

From Table 1, it has been found that a classification accuracy tends to be improved when a data set of annotated text data obtained through the method of the present disclosure (e.g., a method of expanding annotated text data by using a prediction complementary model that creates new annotated text data, with reference to an annotation label y and the context of a text S) is used (e.g., Example 1 and Example 2).

### Arithmetic Example B

After a classification model STT on movie reviews was trained by using an expanded data set obtained by using “CNN/context+label” (condition of Example 1 in Arithmetic Example A) as a prediction complementary model, annotated text data, that is, annotated text data constituted by a combination of text data “the actors are fantastic.” and an annotation label “positive” and annotated text data constituted by a combination of text data “the actors are fantastic.” and an annotation label “negative” was input.

With respect to each of words constituting the text data “the actors are fantastic.”, FIG. 4 illustrates the results when top ten words with high probabilities are extracted from probability distributions calculated in the above equation (6) (in the drawing, the smaller the number “1 to 10” on the right, the higher the probability).

The upper part of FIG. 4 (above characters of “positive.” in the drawing) illustrates the results obtained when the annotated text data constituted by the combination of “the text data “the actors are fantastic.”+the annotation label “positive” is input, and the lower part of FIG. 4 (below characters of “negative.” in the drawing) illustrates the results obtained when the annotated text data constituted by the combination of the text data “the actors are fantastic.”+the annotation label “negative” is input.

It has been found that when “w/synonym” (condition of Comparative Example 2 in Arithmetic Example A) is used as a prediction complementary model, for example, “characters,” “movies,” and “stories.” are not extracted as replacement candidates of “actors.” whereas when “CNN/context+label” is used as a prediction complementary model, these words are also included.

It has been found that when “CNN/context+label” is used, in relation to a word having a strong relevance to a label (“fantastic” in the case of the present Arithmetic Example), completely different words are extracted as candidates according to the type of the annotation labels, that is, “positive.” and “negative.”.

### INDUSTRIAL APPLICABILITY

The present disclosure may be applied to the use for training data creation for machine learning of a text classification model.

1. A method for expanding annotated text data, the method comprising:
inputting, by an input device, the annotated text data including a first text appended with a first annotation label to a prediction complementary model; and
creating, by one or more processors, new annotated text data by the prediction complementary model, with reference to the first annotation label and context of the first text.

2. The method according to claim 1, wherein the creating new annotated text data comprises:
extracting, by the one or more processors, a candidate element replaceable with an element within the first text, by an extraction method provided in the prediction complementary model;
creating, by the one or more processors, a second text by replacing the element within the first text with the candidate element; and
appending, by the one or more processors, the first annotation label to the second text.

3. The method according to claim 1, wherein the prediction complementary model is a label-conditioned bidirectional language model.

4. The method according to claim 2, wherein the extraction method comprises calculating a probability distribution by a following equation (1):
p_{τ}(·|y,S\{wᵢ}) (1)
wherein τ represents a temperature parameter, y represents an annotation label, S represents a text, and wᵢ represents an element in a text.

5. The method according to claim 2, wherein the element within the first text is a word.

6. The method according to claim 1, further comprising:
training, by the one or more processors prior to the inputting annotated text data, the prediction complementary model by using a text data set having no label as training data.

7. The method according to claim 1, wherein the first annotation label is one of (1) a positive annotation label indicating that text data has a positive meaning or (2) a negative annotation label indicating that text data has a negative meaning.

8. A non-transitory computer readable storage medium storing a program for expanding annotated text data, the program, when executed by one or more processors, causing the one or more processors to perform an expansion of the annotated text data,
wherein the program causes the one or more processors to:
input the annotated text data including a first text appended with a first annotation label to a prediction complementary model; and
create new annotated text data by the prediction complementary model, with reference to the first annotation label and context of the first text.

9. A device for expanding annotated text data, the device comprising:
a storage configured to store a prediction complementary model;
an input device configured to input the annotated text data including a first text appended with a first annotation label; and
one or more processors coupled to the storage and the input device and configured to perform arithmetic processings of creating new annotated text data by the prediction complementary model, with reference to the first annotation label and context of the first text.

10. The device according to claim 9, wherein the one or more processors are further configured to:
extract a candidate element replaceable with an element within the first text, by an extraction method provided in the prediction complementary model;
create a second text by replacing the element within the first text with the candidate element; and
append an annotation label identical to the first annotation label, to the second text.

11. The device according to claim 9 wherein the prediction complementary model is a label-conditioned bidirectional language model.

12. The device according to claim 10, wherein the extraction method comprises calculating a probability distribution by a following equation (1):
p_{τ}(·|y,S\{wᵢ}) (1)
wherein τ represents a temperature parameter, y represents an annotation label, S represents a text, and wᵢ represents an element in a text.

13. The device according to claim 10, wherein the element within the first text is a word.

14. The device according to claim 9, wherein the one or more processors are further configured to:
train, prior to the inputting annotated text data, the prediction complementary model by using a text data set having no label as training data.

15. The device according to claim 9, wherein the first annotation label is one of (1) a positive annotation label indicating that text data has a positive meaning or (2) a negative annotation label indicating that text data has a negative meaning.

16. A method for training a text classification model, the method comprising using an expanded data set obtained by the annotated text data expanding method according to claim 1 as training data for a text classification model.

17. The method according to claim 16, wherein the creating new annotated text data comprises:
extracting, by the one or more processors, a candidate element replaceable with an element within the first text, by an extraction method provided in the prediction complementary model;
creating, by the one or more processors, a second text by replacing the element within the first text with the candidate element; and
appending, by the one or more processors, the first annotation label to the second text.

18. The method according to claim 16, wherein the prediction complementary model is a label-conditioned bidirectional language model.

19. The method according to claim 17, wherein the extraction method comprises calculating a probability distribution by a following equation (1):
p_{τ}(·|y,S\{wᵢ}) (1)
wherein τ represents a temperature parameter, y represents an annotation label, S represents a text, and wᵢ represents an element in a text.
